(19) United States
(12) Patent Application Publication
(10) Pub. No.: US 2008/0119145 A1
(43) Pub. Date: May 22, 2008

(54) Hybrid duplex apparatus and method for supporting low-complexity terminal in wireless communication system

(75) Inventors: Joo-Hyun Lee, Suwon-si (KR); Jae-Kon Lee, Suwon-si (KR); Sang-Boh Yun, Seongnam-si (KR); Young-Hoon Kwon, Seongnam-si (KR); Oh-Soon Shin, Suwon-si (KR)

Correspondence Address: DOCKET CLERK, P.O. DRAWER 800889, DALLAS, TX, 75380, US

(73) Assignees: SAMSUNG ELECTRONICS CO., LTD., Suwon-si (KR); Korea Advanced Institute of Science and Technology

(21) Appl. No.: 11/986,449

(22) Filed: Nov. 21, 2007

(30) Foreign Application Priority Data
Nov. 21, 2006 (KR) 2006-0114998

(51) Int. Cl. H04B 1/02

(52) U.S. Cl. 455/101

(57) ABSTRACT

Hybrid Duplex (DUAL MODE) apparatus and method for supporting a low-complexity terminal in a wireless communication system are provided. The apparatus includes a frequency generator and controller for selecting a frequency for one of the dual mode according to a scheduling and generating a control signal for a Duplexer/Switch switching to the selected mode; and a reconfigurable radio frequency (RF) filter/mixer for up-converting an input intermediate frequency (IF) signal to an RF signal using the selected frequency. Accordingly, the DUAL MODE service of the low-complexity terminal can be supported effectively.

### CROSS-REFERENCE TO RELATED APPLICATION(S) AND CLAIM OF PRIORITY

This application claims priority under 35 U.S.C. §119(a) to an application filed in the Korean Intellectual Property Office on Nov. 21, 2006 and assigned Serial No. 2006-114998, the contents of which are incorporated herein by reference.

### TECHNICAL FIELD OF THE INVENTION

The present invention relates generally to a full-duplex wireless communication system, and in particular, to a Hybrid Duplex (DUAL MODE) apparatus and method for supporting a low-complexity terminal.

### BACKGROUND OF THE INVENTION

For bidirectional communications in a wireless communication system, a duplex method is necessary to distinguish a downlink (DL) transmission and an uplink (UL) transmission. The duplex method generally includes a frequency division duplex (FDD) scheme which separates a DL 101 and a UL 103 by allocating different frequency bands f₁ and f₂ to the DL 101 and the UL 103 as shown in FIG. 1A, and a time division duplex (TDD) scheme which separates a DL 105 and a UL 107, sharing the same frequency band f₁, by allocating different transmission intervals to the DL 105 and the UL 107 as shown in FIG. 1B.

The FDD scheme needs a guard band between the DL band and the UL band to prevent interference between the DL and the UL. Since the ratio of the DL and the UL is fixed by the bandwidth, it is not fit for asymmetric traffic between the variable DL and the variable UL. Thus, while second generation (2G) systems, such as Interim Standard (IS)-95 and Global System for Mobile communications (GSM), for voice-oriented service and most 3G systems for voice service and packet service are adopting FDD schemes, a wireless communication system for asymmetric data oriented service will adopt a TDD scheme because an FDD scheme is unsuitable.

The strongest advantage of the TDD scheme is to effectively deal with the asymmetric traffic by flexibly adjusting the ratio of the DL and the UL. In addition, since the two links, DL and UL, occupy the same band, the TDD scheme can mitigate the feedback overhead for the channel information by using channel reciprocity. Accordingly, the TDD scheme can effectively apply a frequency utilization enhancement technique, such as adaptive modulation and multi-antenna.

Since the traffic ratio of the DL and the UL varies in each cell, it is necessary to change the switching point between the DL and the UL based on the traffic condition for the sake of the effective TDD operation. However, in practice, it is quite hard to change the switching point between the DL and the UL in accordance with the varying traffic ratio of the DL and the UL in every cell. Even if it is possible, when the ratio of the DL and the UL is different in each cell, a cross slot where a certain cell sends a DL signal and another cell sends a UL cell is caused. In the cross slot, interference occurs between base stations of different cells and interference occurs between terminals of different cells, which is called “cross slot interference”. The cross slot interference can be a main cause of the performance degradation of a user in a cell boundary. Since the DL and the UL are separated by the time, even when fast feedback information such as ACK/NACK or Channel Quality Indicator (CQI) change information is generated in the DL interval, the information is not promptly sent to the UL as in the FDD scheme. As a result, the link performance is degraded.

To address the cross slot interference of the TDD scheme and allow the fast feedback as in the FDD scheme, a Hybrid Duplex (DUAL MODE) scheme combining the TDD scheme and the FDD scheme is suggested in FIG. 1C. The DUAL MODE scheme separates a TDD band of a center frequency f₁ using the TDD scheme and a FDD band of a center frequency f₂ dedicated to the UL. The DL transmission occupies the DL interval 109 of the TDD band similar to the TDD scheme, and the UL transmission selectively occupies the UL interval 111 of the TDD band and the UL interval 113 of the FDD band. Although it is not shown, a FDD band of another center frequency dedicated to the UL or the DL can be additionally provided and a TDD band of another center frequency can be additionally provided. As such, having the advantage of the TDD, the DUAL MODE scheme can mitigate the influence of the cross slot interference by allowing the users in the cell boundary to use the UL of the FDD band. Further, by allocating both of the UL of the TDD band and the UL of the FDD band to the users within the cell, the DUAL MODE scheme enables the fast feedback for the DL through the FDD UL. Therefore, the performance enhancement in the DL transmission can be expected.

In the FDD scheme and the TDD scheme, a transmitter and a receiver each require one radio frequency (RF) chain. FIGS. 2A and 2B are structures of RF transceivers of a terminal which supports the FDD and TDD schemes with a single transceiver antenna. The RF transceiver of the FDD scheme of FIG. 2A includes a baseband signal processor 200, a transmit RF chain, a receive RF chain, and a duplexer 209. The RF transceiver of the TDD scheme of FIG. 2B includes a baseband signal processor 220, a transmit RF chain, a receive RF chain, and a switch 229. The transmit RF chains of the FDD scheme and the TDD scheme include digital-to-analog converters (DACs) 201 and 221, in-phase and quadrature phase (I/Q) modulators 202 and 222, intermediate frequency (IF) amplifiers 203 and 223, first IF mixers 204 and 224, first IF filters 205 and 225, first RF mixers 206 and 226, first RF filters 207 and 227, and RF power amplifiers 208 and 228 respectively. The receive RF chains include RF low noise amplifiers (LNAs) 210 and 230, second RF filters 211 and 231, second RF mixers 212 and 232, second IF filters 213 and 233, second IF mixers 214 and 234, IF LNAs 215 and 235, I/Q demodulators 216 and 236, and analog-to digital converters (ADCs) 217 and 237 respectively. Herein, the FDD scheme of FIG. 2A shares the transceiver antenna using the duplexer 209 and the TDD scheme of FIG. 2B share the transceiver antenna using the switch 229.

However, in the transceivers constructed above, since the DUAL MODE scheme uses two different bands as the UL, a terminal requires the transmit RF chains for the two bands and a base station requires the receive RF chains for the two bands. While the base station is subject to the relatively moderate limitation in terms of the cost or the complexity, it is quite hard for the terminal to support the existing DUAL MODE requiring two receive RF chains because of the cost limitation or the complexity limitation.

### SUMMARY OF THE INVENTION

To address the above-discussed deficiencies of the prior art, it is a primary aspect of the present invention to substantially solve at least the above problems and/or disadvantages and to provide at least the advantages below. Accordingly, an aspect of the present invention is to provide a hybrid duplex (DUAL MODE) apparatus and method for supporting a low-complexity terminal in a wireless communication system.

Another aspect of the present invention is to provide a DUAL MODE apparatus and method for supporting a low-complexity terminal which employs a reconfigurable radio-frequency (RF) chain in a full-duplex wireless communication system.

Yet another aspect of the present invention is to provide a DUAL MODE structure for separating an uplink (UL) transmit interval of a frequency division duplex (FDD) band so that a terminal including a reconfigurable RF chain supporting both time division duplex (TDD) and FDD independently can support DUAL MODE service, and for allocating resources not to send UL signals in the TDD band and the FDD band at the same time in a full-duplex wireless communication system.

Still another aspect of the present invention is to provide a DUAL MODED operating apparatus and method for supporting a full-DUAL MODE terminal and a terminal including a reconfigurable RF chain according to whether the full-DUAL MODE of the terminal is supported and the terminal position in a full-duplex wireless communication system.

The above aspects are achieved by providing a DUAL MODE transmitter in a wireless communication system, which includes a frequency generator and controller for selecting a frequency for one of the dual mode according to a scheduling and generating a control signal for a Duplexer/Switch switching to the selected mode; and a reconfigurable radio frequency (RF) filter/mixer for up-converting an input intermediate frequency (IF) signal to an RF signal using the selected frequency.

According to the aspect of the present invention, a DUAL MODE operating method of a base station in a wireless communication system includes when there is a terminal attempting an initial access, examining whether the terminal supports two or more UL bands using a single transmit RF chains (hereafter, referred to as a low-complexity terminal) and examining a position of the terminal; and allocating resources to the terminal to the examination results.

According to the aspect of the present invention, a DUAL MODE operating apparatus of a base station in a wireless communication system includes the base station for, when there is a terminal attempting an initial access, examining whether the terminal supports two or more UL bands using a single transmit RF chain (hereafter, referred to as a low-complexity terminal) and examining a position of the terminal, and allocating resources to the terminal according to the examination results; and the terminal for allocating the resources from the base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same It should be noted that the functionality associated with any particular controller may be centralized or distributed, whether locally or remotely Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A, 1B and 1C are diagrams of conventional FDD, TDD, and DUAL MODE frames;

FIGS. 2A and 2B are block diagrams of RF transceivers of a conventional terminal supporting the FDD and TDD schemes;

FIG. 3 is a block diagram of an RF transceiver of a low-complexity terminal supporting a DUAL MODE scheme in a wireless communication system according to the present invention;

FIGS. 4A and 4B are diagrams of a DUAL MODE frame for supporting the low-complexity terminal in the wireless communication system according to the present invention;

FIG. 5 is a flowchart of a DUAL MODE operating method for supporting both the low-complexity terminal and a full-DUAL MODE terminal in the wireless communication system according to the present invention; and

FIG. 6 is a diagram of the terminal characteristic transmission by separating ranging channels in the wireless communication system according to the present invention.

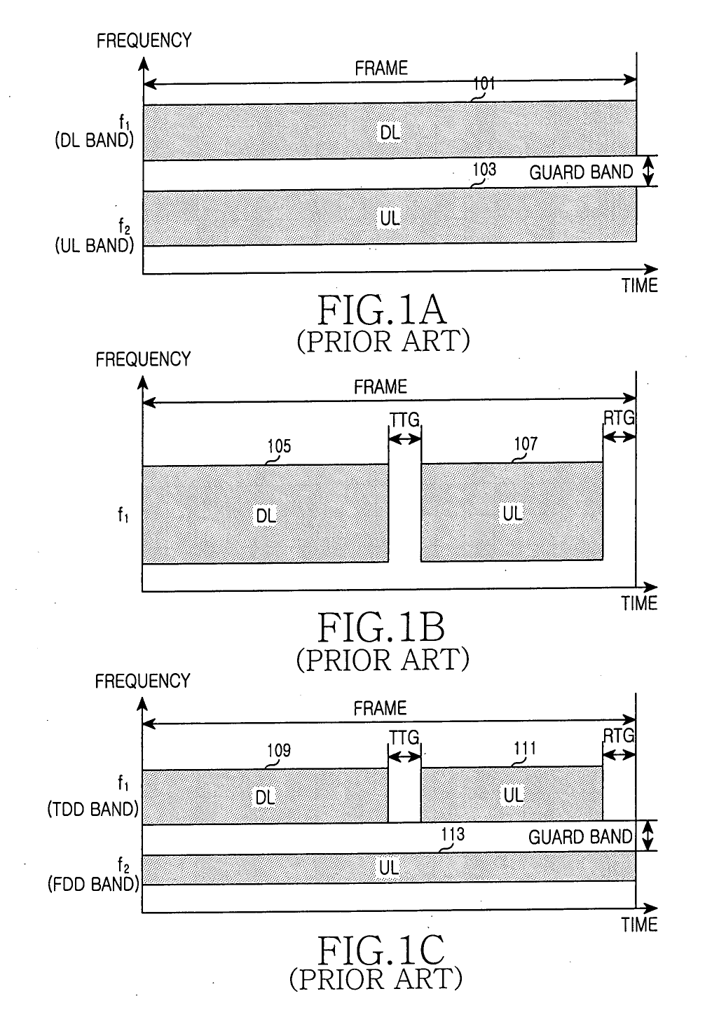

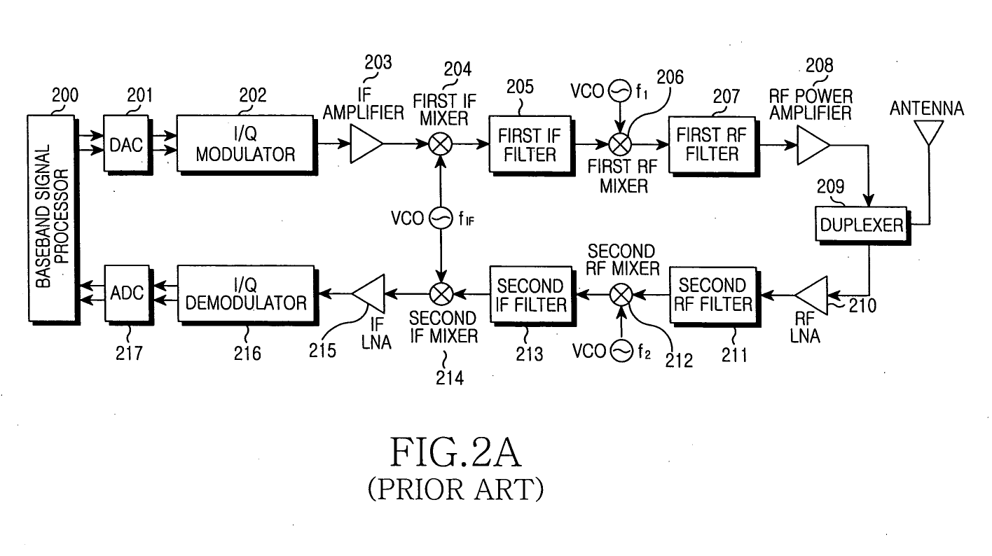

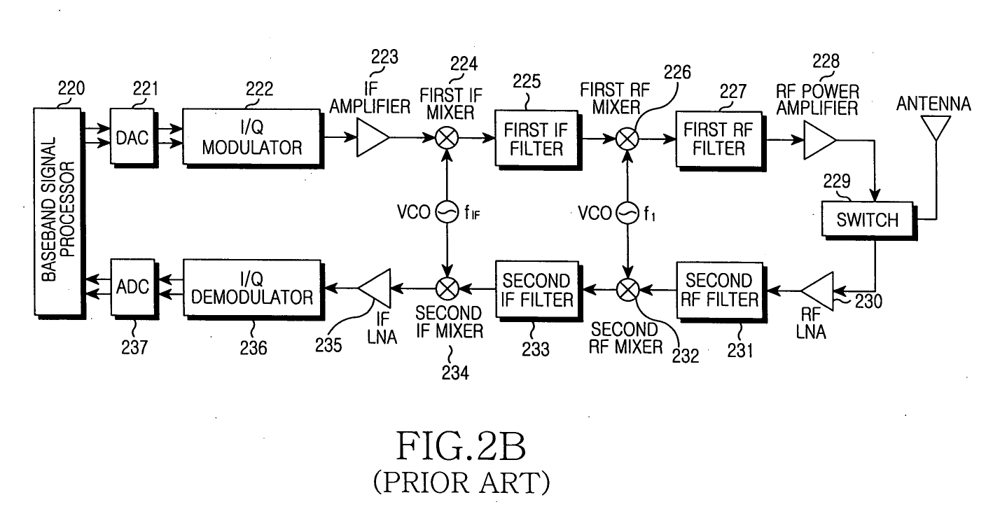

### DETAILED DESCRIPTION OF THE INVENTION

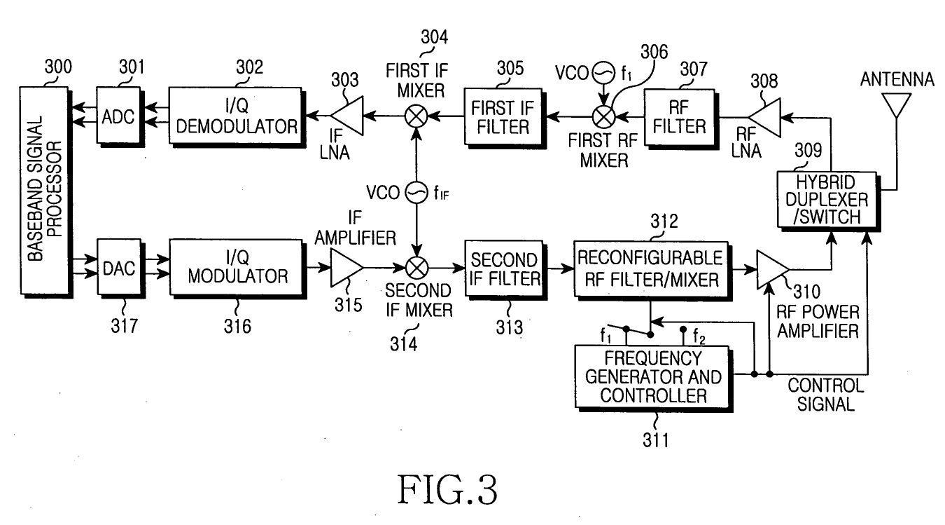

FIGS. 3 through 6, discussed below, and the various embodiments used to describe the principles of the present disclosure in this patent document are by way of illustration only and should not be construed in any way to limit the scope of the disclosure Those skilled in the art will understand that the principles of the present disclosure may be implemented in any suitably arranged wireless communication system.

The present invention provides a Hybrid Duplex (DUAL MODE) apparatus and method for supporting a low-complexity terminal in a wireless communication system.

The low-complexity terminal supports the DUAL MODE scheme by sharing the same transmit radio frequency (RF) chain, without implementing separate transmit RF chains for a Time Division Duplex (TDD) band and a Frequency Division Duplex (FDD) scheme. Compared to a terminal supporting the DUAL MODE scheme using the transmit RF chains respectively for the TDD band and the FDD band (hereafter, referred to as a full-DUAL MODE terminal), the low-complexity terminal can mitigate the complexity. Likewise, a base station can be constituted to share the same receive RF chain for TDD and FDD bands. In the following, a terminal exhibiting great complexity reduction is described.

According to the present invention, while the low-complexity terminal supports the DUAL MODE scheme by sharing the same transmit RF chain for one TDD band and one FDD band, by way of example, the present invention is applicable to two more TDD bands or FDD bands.

FIG. 3 is a block diagram of an RF transceiver of the low-complexity terminal supporting the DUAL MODE scheme in a wireless communication system according to the present invention.

The low-complexity terminal of FIG. 3 includes a baseband signal processor 300, a receive RF chain 301 through 308, a transmit RF chain 310 and 312 through 317, a frequency generator and controller 311, and a hybrid duplexer/switch 309. The receive RF chain for a TDD band based on a center frequency f₁ includes an RF low noise amplifier (LNA) 308, an RF filter 307, a first RF mixer 306, a first intermediate frequency (IF) filter 305, a first IF mixer 304, an IF LNA 303, an in-phase and quadrature phase (I/Q) demodulator 302, and an analog-to-digital converter (ADC) 301. The transmit RF chain for the TDD band or the FDD band based on a center frequency f2 includes a digital-to-analog converter (DAC) 317, an I/Q modulator 316, an IF amplifier 315, a second IF mixer 314, a second IF filter 313, a reconfigurable RF filter/mixer 312, and an RF power amplifier 310. The receive RF chain 301 through 308 and the transmit RF chain 310 and 312 through 317 share a transceiver antenna using the hybrid duplexer/switch 309. Hereafter, the transmit RF chain of the low-complexity terminal is referred to as a reconfigurable RF chain.

In FIG. 3, the receive RF chain operates in a TDD band mode, and the transmit RF chain operates in a TDD band mode or a FDD band mode according to the frequency generated at the frequency generator and controller 311.

The RF LNA 308 of the receive RF chain amplifies a signal received on the connected antenna to a certain level and outputs the amplified signal to the RF filter 307. The RF filter 307 filters only an intended signal from the amplified signal and outputs the filtered signal to the first RF mixer 306. The first RF mixer 306 down-converts the filtered RF signal to an IF band and outputs the converted signal to the first IF filter 305. The first IF filter 305 filters only an intended channel from the down-converted signal and outputs the filtered signal to the first IF mixer 304. The first IF mixer 304 down-converts the filtered signal to a baseband and outputs the converted signal to the IF LNA 303. The IF LNA 303 amplifies the down-converted signal to a certain level and outputs the amplified signal to the I/Q demodulator 302. The I/Q demodulator 302 converts the amplified signal to the un-modulated signal of I axis and Q axis and outputs the converted signal to the ADC 301. The ADC 301 converts the demodulated analog signal to a digital signal and outputs the digital signal to the baseband signal processor 300.

The DAC 317 of the transmit RF chain converts the digital signal fed from the baseband signal processor 300 to an analog signal and outputs the analog signal to the I/Q modulator 316. The I/Q modulator 316 converts the input signal of the I axis and the Q axis to a high frequency having a phase difference between the I-axis signal and the Q-axis signal, combines the two signals, and outputs the combined signal to the IF amplifier 315. The IF amplifier 315 IF-amplifies the modulated signal to a certain level and outputs the amplified signal to the second IF mixer 314. The second IF mixer 314 up-converts the IF-amplified signal to the IF band and outputs the up-converted signal to the second IF filter 313. The second IF filter 313 filters only an intended channel from the up-converted signal and outputs the filtered signal to the reconfigurable RF filter/mixer 312. The reconfigurable RF filter/mixer 312 up-converts the filtered IF signal to the RF band, filters only the intended channel from the up-converted signal, and outputs the filtered signal to the RF power amplifier 310. In doing so, the reconfigurable RF filter/mixer 312 operates in the TDD band mode or the FDD band mode according to the frequency band generated at the frequency generator and controller 311. The RF power amplifier 310 amplifies the signal converted to the RF frequency to a high level so that the signal can be transmitted with sufficient power, and provides the amplified signal to the receiving end via the connected antenna.

The frequency generator and controller 311 generates the corresponding frequency to the reconfigurable RF filter/mixer 312 by switching the frequency of the transmit RF chain connected to the antenna to one of the TDD band f₁ and the FDD band f₂ according to the UL band allocated from a base station. The frequency generator and controller 311 issues a control signal to the RF power amplifier 310 according to the UL band allocated by the base station and provides the amplification level of the corresponding frequency band. The frequency generator and controller 311 issues a control signal to the hybrid duplexer/switch 309 connected to the antenna according to the UL band allocated by the base station, thus controlling the transmit RF chain of the terminal to act as the switch in the TDD band mode and to act as the duplexer in the FDD band mode.

In more detail, when the terminal operates in the TDD band mode in the f₁ band, the frequency generator and controller 311 generates the frequency f₁ to the reconfigurable RF filter/mixer 312, issues a control signal to the hybrid duplexer/switch 309 to operate as the switch, and provides the amplification level for the frequency band f₁ to the RF power amplifier 310. By contrast, when the terminal operates in the FDD band mode in the bands f₁ and f₂, the frequency generator and controller 311 generates the frequency f₂ to the reconfigurable RF filter/mixer 312, issues a control signal to the hybrid duplexer/switch 309 to act as the duplexer, and provides the amplification level for the frequency band f₂ to the RF power amplifier 310.

According to the control signal fed from the frequency generator and controller 311, the hybrid duplexer/switch 309 acts as the switch when the transmit RF chain of the terminal is in the TDD band mode and acts as the duplexer when the transmit RF chain of the terminal is in the FDD band mode.

Since the low-complexity terminal of the present invention supports the DUAL MODE scheme by sharing the transmit RF chain for the two bands TDD and FDD, it cannot support uplinks of the two bands TDD and FDD at the same time. Accordingly, a DUAL MODE frame structure and its operating method are required to separate the UL transmit interval in the FDD band and to prevent the low-complexity terminal from allocating the two band ULs at the same time.

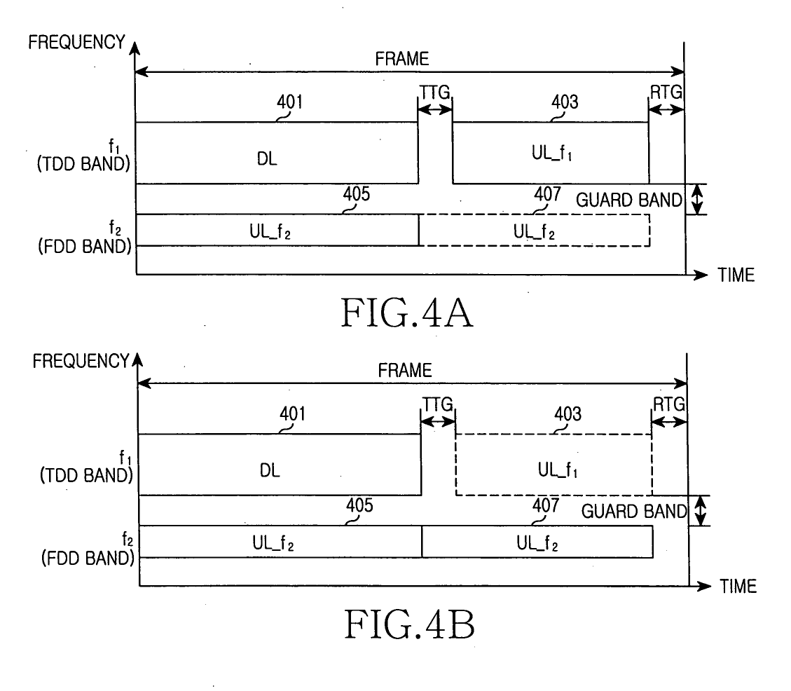

FIGS. 4A and 4B are diagrams of a DUAL MODE frame for supporting the low-complexity terminal in the wireless communication system according to the present invention.

The DUAL MODE frame structure for supporting the low-complexity terminal can be divided to a DL interval 401 and a UL interval UL_f₁ 403 in the TDD band based on a center frequency f₁, and a first UL interval UL_f₂ 405 and a second UL interval UL_f₂ 407 in the FDD band based on a center frequency f₂ as shown in FIGS. 4A and 4B. A Transmit Transition Gap (TTG) or a Receive Transition Gap (RTG) is inserted between the DL interval 401 and the UL interval UL_f₁ 403 of the TDD band or between the UL interval UL_f₁ 403 and the DL interval 401. The lengths of the DL interval 401 and the UL interval UL_f₁ 403 can be changed by taking into account the asymmetry of the traffic. The DL interval 401 of the TDD band and the first UL interval UL_f₂ 405 of the FDD band synchronize their start point and end point in one frame. The second UL interval UL_f₂ 407 of the FDD band may be defined from the end point to the remaining interval of the frame or from the end point to the remaining interval excluding the RTG in the frame.

Not to allocate the uplinks of the two bands TDD and FDD to the low-complexity terminal at the same time, a base station allocates the UL interval UL_f₁ 403 of the TDD band and the first UL interval UL_f₂ 405 of the FDD band to the terminal as shown in FIG. 4A, or allocates the first UL interval UL_f₂ 405 and the second UL interval UL_f₂ 407 of the FDD band to the terminal as shown in FIG. 4B, based on a certain criterion. For example, the certain criterion can be the position of the terminal and the base station can allocate the band of the different structure to the terminal according to the terminal position. More specifically, when the low-complexity terminal is located within the cell, the base station allocates the UL interval UL_f₁ 403 of the TDD band and the first UL interval UL_f₂ 405 of the FDD band to the terminal as shown in FIG. 4A. When the low-complexity terminal is in the cell boundary, the base station allocates the first UL interval UL_f₂ 405 and the second UL interval UL_f₂ 407 of the FDD band as shown in FIG. 4B. [041]The low-complexity terminal, which is assigned the UL interval UL_f₁ 403 of the TDD band and the first UL interval UL_f₂ 405 of the FDD band as shown in FIG. 4A, basically sends DL and UL data over the DL interval 401 and the UL interval UL_f₁ 403 of the TDD band. Fast feedback information generated in the DL data transmission is transmitted over the first UL interval UL_f₂ 405 of the FDD band. The low-complexity terminal, which is assigned the first UL interval UL_f₂ 405 and the second UL interval UL_f₂ 407 of the FDD band as shown in FIG. 4B, basically sends DL and UL data over the DL interval 401 of the TDD band and the second UL interval UL_f₂ 407 of the FDD band. Fast feedback information generated in the DL data transmission is transmitted over the first UL interval UL_f₂ 405 of the FDD band.

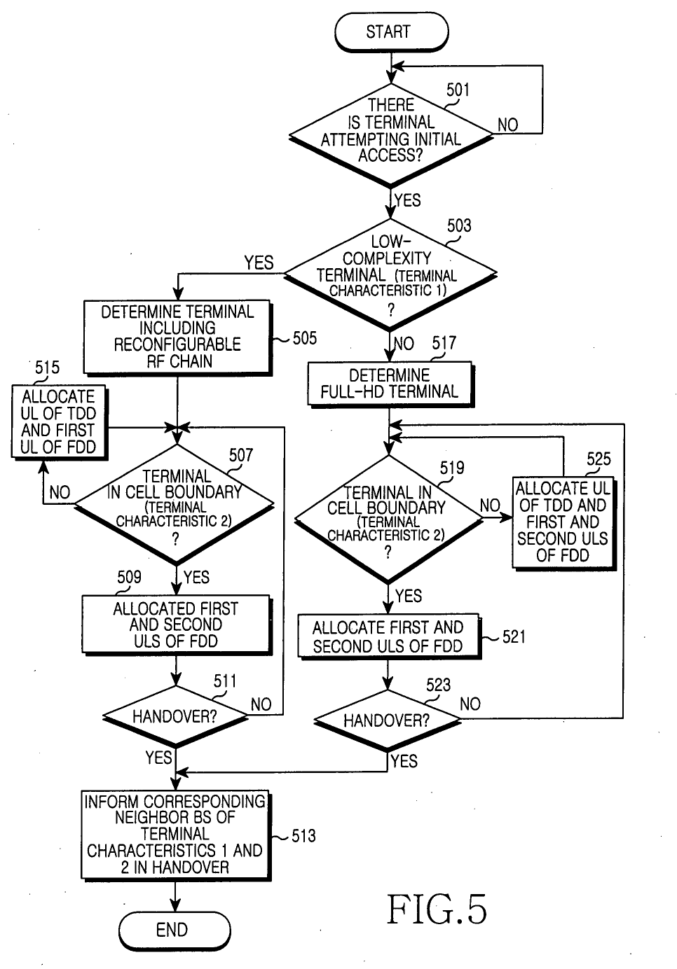

FIG. 5 is a flowchart of a DUAL MODE operating method for supporting both the low-complexity terminal and the full-DUAL MODE terminal in the wireless communication system according to the present invention.

The base station examines whether there is a terminal attempting the initial access in step 501. When there is the terminal attempting the initial access, the base station determines whether the terminal of the initial access is a low-complexity terminal (terminal characteristic 1) in step 503.

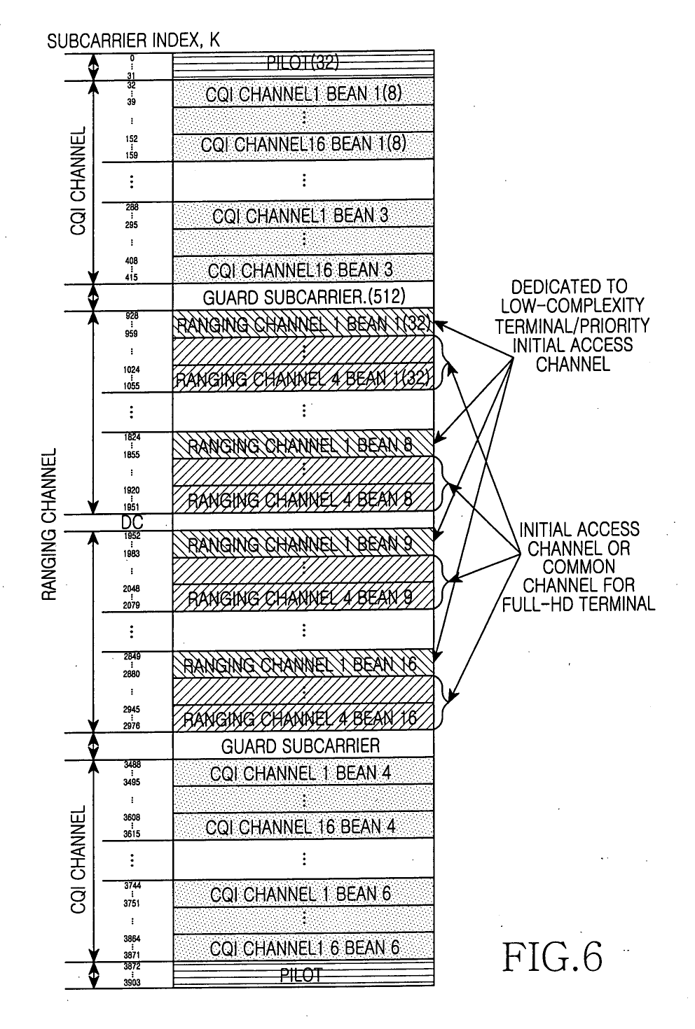

Whether the terminal of the initial access is the low-complexity terminal can be determined using various methods. For example, the base station receives a message including the terminal characteristic from the corresponding terminal, or the base station distinguishes a ranging channel or a code in the initial access. FIG. 6 is a diagram of the terminal characteristic transmission by separating ranging channels. By dedicating part of the ranging channels to the low-complexity terminal, the base station can determine the terminal attempting the initial access through a specific ranging channel as the low-complexity terminal. Conversely, by allowing the full-DUAL MODE terminal to attempt the initial access through other ranging channel, the base station can determine the terminal characteristic. After the initial access, the base station reallocates an adequate ranging channel based on the terminal characteristic. In the DUAL MODE initial service phase where the full-DUAL MODE terminal is not generalized, a specific ranging channel or code can be allocated to the terminal having two transmit RF chains and the low-complexity terminal can freely use the other ranging channels.

When the terminal attempting the initial access is the low-complexity terminal, the base station determines the TDD/FDD common low-complexity terminal having the reconfigurable RF chain in step 505 and examines whether the terminal is positioned in the cell boundary (terminal characteristic 2) in step 507. When the terminal is within the cell, the base station allocates to the terminal the DL interval 401 and the UL interval UL_f₁ 403 of the TDD band based on the center frequency f₁ and the first UL interval UL_f₂405 of the FDD band based on the center frequency f₂ to the terminal in step 515 and returns to the step 507.

By contrast, when the terminal is in the cell boundary, the base station allocates to the terminal the DL interval 401 of the TDD band based on the center frequency f₁ and the first UL interval UL_f₂ 405 and the second UL interval UL_f₂ 407 of the FDD band based on the center frequency f₂ in step 509 and examines whether the terminal is handed over in step 511. When the terminal is not handed over, the base station goes back to step 507. When the terminal is handed over, the base station informs a corresponding neighbor base station that the terminal is the low-complexity terminal in the cell boundary by providing the terminal characteristics 1 and 2 to the neighbor base station in step 513.

Meanwhile, when the terminal attempting the initial access is not the low-complexity terminal in step 503, the base station determines the terminal as the full-DUAL MODE terminal in step 517 and examines whether the terminal is in the cell boundary (terminal characteristic 2) in step 519. When the terminal is within the cell, the base station allocates all of the DL interval 401 and the UL interval UL_f₁ 403 of the TDD band based on the center frequency f₁ and the first UL interval UL_f₂ 405 and the second UL interval UL_f₂ 407 of the FDD band based on the center frequency f₂ to the terminal in step 525, and goes back to step 519.

By contrast, when the terminal is in the cell boundary, the base station allocates the UL interval 401 of the TDD band based on the center frequency f₁ and the first UL interval UL_f₂ 405 and the second UL interval UL_f₂ 407 of the FDD band of the center frequency f₂ to the terminal in step 521, and examines whether the terminal is handed over in step 523. When the terminal is not handed over, the base station goes back to step 519. When the terminal is handed over, the base station informs a corresponding neighbor base station that the terminal is the full-DUAL MODE terminal in the cell boundary by providing the terminal characteristics 1 and 2 to the neighbor base station in step 513.

Next, the base station finishes this process. [050]Herein, the position of the terminal can be estimated by calculating a relative distance to the distance such that, for example, a Carrier to Interference and Noise Ratio (CINR) measured by the terminal to estimate the interference of a neighbor cell is fed back to the base station or the base station measures a Received Signal Strength Indicator (RSSI) of the terminal. Advantageously, the UL of the TDD band is allocated to the terminal which suffers less interference from the neighbor cell, has the great RSSI, travels within the cell, and the UL of the FDD band is allocated to the terminal which suffers great interference of the neighbor cell, has the small RSSI, and travels in the cell boundary.

Since the base station allocates the resources by periodically measuring the terminal characteristic, not only the full-DUAL MODE terminal but also the low-complexity terminal can acquire the gains of the TDD and FDD schemes.

The full-duplex wireless communication system of the present invention separates the UL transmit intervals of the FDD band so that the terminal including the reconfigurable RF chain for independently supporting both the TDD and the FDD can support the DUAL MODE service. The DUAL MODE structure allocates the resources not to transmit the UL signal in the TDD band and the FDD band at the same time. The DUAL MODE operating method supports the full-DUAL MODE terminal and the terminal including the reconfigurable RF chain according to whether the full DUAL MODE of the terminal is supported and the terminal's position information. Therefore, not only the full-DUAL MODE terminal but also the low-complexity terminal can effectively support the DUAL MODE service. Further, as supporting the low-complexity terminal including the reconfigurable RF chain using the DUAL MODE structure, the RF chain area can be reduced by 30% or so, compared to the conventional terminal including the two transmit RF chains.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A DUAL MODE transmitter in a wireless communication system, the transmitter comprising:
a frequency generator and controller for selecting a frequency for one of the dual mode according to a scheduling and generating a control signal for a Duplexer/Switch switching to the selected mode; and
a reconfigurable radio frequency (RF) filter/mixer for up-converting an input intermediate frequency (IF) signal to an RF signal using the selected frequency.

2. The DUAL MODE transmitter of claim 1, wherein the reconfigurable RF filter/mixer filters only an intended channel from the up-converted signal and outputs the filtered signal.

3. The DUAL MODE transmitter of claim 1, further comprising:
an RF power amplifier for amplifying the up-converted signal to a corresponding amplification level according to a control signal of the frequency generator and controller,
wherein the frequency generator and controller outputs a control signal corresponding to the generated frequency to the RF power amplifier.

4. The DUAL MODE transmitter of claim 1, further comprising: An RF power amplifier for amplifying the up-converted signal wherein the RF power amplifier supports the RF power corresponding all frequency of dual mode.

5. The DUAL MODE transmitter of claim 1, wherein the frequency generator and controller is located at a mobile station to select the frequency corresponding one of uplink TDD band and uplink FDD band or at a base station to select the frequency corresponding downlink TDD or downlink FDD band.

6. The DUAL MODE transmitter of claim 1, wherein the duplexer/switch is selected one of duplexer and switch according to the selected mode, the duplexer is useful for the FDD band and the switch is useful for selecting the Uplink TDD band or the Downlink TDD band.

7. A DUAL MODE operating method of a base station in a wireless communication system, the method comprising:
when there is a terminal attempting an initial access, examining whether the terminal supports two or more uplink (UL) bands using a single transmit radio frequency (RF) chains (hereafter, referred to as a low-complexity terminal) and examining a position of the terminal; and
allocating resources to the terminal to the examination results.

8. The DUAL MODE operating method of claim 7, wherein a DUAL MODE frame structure comprises a downlink (DL) interval and a UL interval of a Time Division Duplex (TDD) band based on a first center frequency, and a first UL interval and a second UL interval of a Frequency Division Duplex (FDD) band based on a second center frequency.

9. The DUAL MODE operating method of claim 8, wherein lengths of the DL interval and the UL interval of the TDD band based on the first center frequency are variably set by taking into account asymmetry of a traffic.

10. The DUAL MODE operating method of claim 8, wherein the resource allocating comprises:
when the terminal is the low-complexity terminal in a cell boundary, allocating the DL interval of the TDD band based on the first center frequency, and the first UL interval and the second UL interval of the FDD band based on the second center frequency to the terminal;
when the terminal is the low-complexity terminal in the cell, allocating the DL interval and the UL interval of the TDD band based on the first center frequency, and the first UL interval of the FDD band based on the second center frequency to the terminal;
when the terminal supports a single UL band using a single transmit RF channel in the cell boundary, allocating the DL interval of the TDD band based on the first center frequency, and the first UL interval and the second UL interval of the FDD band based on the second center frequency to the terminal; and
when the terminal supports a single UL band using a single transmit RF channel in the cell, allocating the DL interval and the UL interval of the TDD band based on the first center frequency, and the first UL interval and the second UL interval of the FDD band based on the second center frequency to the terminal.

11. The DUAL MODE operating method of claim 10, wherein the resource allocating further comprises:
when the terminal in the cell boundary is handed over, informing a corresponding neighbor base station of whether the terminal is the low-complexity terminal and of the terminal position information in the handover procedure.

12. The DUAL MODE operating method of claim 8, wherein the DL interval of the TDD band of the first center frequency and the first UL interval of the FDD band of the second center frequency synchronize a start point and an end point in a frame.

13. The DUAL MODE operating method of claim 7, wherein whether the terminal is the low-complexity terminal is determined by receiving a message containing information relating to whether the terminal is the low-complexity terminal, from the terminal.

14. The DUAL MODE operating method of claim 7, wherein whether the terminal is the low-complexity terminal is determined by examining whether the terminal attempts an initial access through a specific dedicated ranging change.

15. The DUAL MODE operating method of claim 7, wherein the position of the terminal is determined by receiving a Carrier to Interference and Noise Ratio (CINR) fed back from the terminal.

16. The DUAL MODE operating method of claim 7, wherein the position of the terminal is determined by measuring a Received Signal Strength Indicator (RSSI) of the terminal and calculating a relative distance to the terminal.

17. A DUAL MODE operating apparatus of a base station in a wireless communication system, the apparatus comprising:
the base station for, when there is a terminal attempting an initial access, examining whether the terminal supports two or more uplink (UL) bands using a single transmit Radio Frequency (RF) chain (hereafter, referred to as a low-complexity terminal) and examining a position of the terminal, and allocating resources to the terminal according to the examination results; and
the terminal for allocating the resources from the base station.

18. The DUAL MODE operating apparatus of claim 17, wherein a DUAL MODE frame structure comprises a downlink (DL) interval and a UL interval of a Time Division Duplex (TDD) band based on a first center frequency, and a first UL interval and a second UL interval of a Frequency Division Duplex (FDD) band based on a second center frequency.

19. The DUAL MODE operating apparatus of claim 18, wherein lengths of the DL interval and the UL interval of the TDD band based on the first center frequency are variably set by taking into account asymmetry of a traffic.

20. The DUAL MODE operating apparatus of claim 18, wherein, when the terminal is the low-complexity terminal in a cell boundary, the base station allocates the DL interval of the TDD band based on the first center frequency and the first UL interval and the second UL interval of the FDD band based on the second center frequency to the terminal,
when the terminal is the low-complexity terminal in the cell, the base station allocates the DL interval and the UL interval of the TDD band based on the first center frequency and the first UL interval of the FDD band based on the second center frequency to the terminal,
when the terminal supports a single UL band using a single transmit RF channel in the cell boundary, the base station allocates the DL interval of the TDD band based on the first center frequency and the first UL interval and the second UL interval of the FDD band based on the second center frequency to the terminal, and
when the terminal supports a single UL band using a single transmit RF channel in the cell, the base station allocates the DL interval and the UL interval of the TDD band based on the first center frequency and the first UL interval and the second UL interval of the FDD band based on the second center frequency to the terminal.

21. The DUAL MODE operating apparatus of claim 20, wherein, when the terminal in the cell boundary is handed over, the base station informs a corresponding neighbor base station of whether the terminal is the low-complexity terminal and of the terminal position information in the handover procedure.

22. The DUAL MODE operating apparatus of claim 18, wherein the DL interval of the TDD band of the first center frequency and the first UL interval of the FDD band of the second center frequency synchronize a start point and an end point in a frame.

23. The DUAL MODE operating apparatus of claim 17, wherein the base station determines whether the terminal is the low-complexity terminal by receiving a message containing information relating to whether the terminal is the low-complexity terminal, from the terminal, or by examining whether the terminal attempts an initial access through a specific dedicated ranging change.

24. The DUAL MODE operating apparatus of claim 17, wherein the base station determines the position of the terminal by receiving a Carrier to Interference and Noise Ratio (CINR) fed back from the terminal.

25. The DUAL MODE operating apparatus of claim 17, wherein the base station determines the position of the terminal by measuring a Received Signal Strength Indicator (RSSI) of the terminal and calculating a relative distance to the terminal.
